(19) United States
(12) Patent Application Publication
(10) Pub. No.: US 2013/0034833 A1
(43) Pub. Date: Feb. 7, 2013

(54) Disposable mouth chip - DMC

(71) Applicant: SEAN A. RASHTI, Encino, CA (US)

(72) Inventor: SEAN A. RASHTI, Encino, CA (US)

(21) Appl. No.: 13/198,516

(22) Filed: Aug. 4, 2011

(51) Int. Cl. A61C 17/00; A47L 13/10

(52) U.S. Cl. 433/216; 15/210.1

(57) ABSTRACT

A disposable mouth article, with specialized micro-structure fashioned from predetermined biodegradable biopolymers in predetermined shape, color, and size with selected macro features enabling the embodiment to have a diversity of functions i.e. providing excellent oral cleaning power in a novel embodiment, convenient packaging, miniaturized, novel functional dynamic architecture for providing novel automatic brushing, providing a novel means of focused dental optoelectric therapy, providing novel means of drug delivery, providing novel insitu reactions, providing novel means for delivery of heat, gas, jet pressure, providing novel means for regulated dispensing of biologically active molecules, providing built-in safety mechanisms for use by prison inmates, providing novel solid expectorant, providing new means of advertising, providing new economy.

### BACKGROUND

1. Field of Invention

This invention is related to single use disposable oral appliance, that cleans teeth and oral mucosa, traps bacteria and particles, and functions in novel treatment/drug delivery for controlled substances, and allows insitu reactions.

2. Description of Prior Art

Disadvantages of prior art for disposable oral cleaning apparatuses can be categorized by simplicity of use, carry and travel, space consumption, biodegradable manufacturing, compliance of use by children and elderly, safety for prison inmates, use for airline industry, hospitals and other specific target groups. The present invention is a biodegradable, disposable, oral appliance used for oral hygiene that is independent of a guiding stick as in conventional tooth brush, and it does not require attachment to tongue or a finger to guide it; it is designed for use especially by the elderly, children, physically or mentally disabled, with special considerations for safety requirements on board of planes, use in prisons, and military use. This item is also designed for insitu reactions and delivery of biomolecules with short half life. There are no prior art for embodiments that allow insitu reactions, within body cavities or as implants.

U.S. Pat. Nos. 463,309, 2,966,691, 3,902,509, 3,934,299, 4,335,731, 4,617,694, 4,975,247, 5,213,428, 5,440,774, 6,105,587, 6,378,698, disclose finger mounted objects with creative use of surfaces impregnated with dentifrice. The surfaces of the disclosed are fabric, textile, and paper with shrinking or elastic tread. They are worn over a finger, e.g. like a thimble, or condom and here lies the limitation of use, requiring a finger of variable girth to be shoved inside a mouth of variable size, for operation. This is an invasive procedure with unacceptable variables for children and elderly. Dexterity of elderly and children are other variables in question for efficacious use. U.K Pat. No. 2048073, Swiss Pat. No. 633709 are the same in concept of a finger pullover of fabric/cloth impregnated with dentifrice with identical limitation.

U.S. Pat. No. 6,722,805 discloses a tongue adhering dentifrice apparatus. However, what adheres to the tongue must be peeled. Besides causing a sensitivity problem after use and swelling after applying the suction cup to the tongue, the range of movement for tongue in a mouth is limited to where its tip can go. Much of the oral cavity can not be explored by the tip of the tongue. More importantly on the list of reasons for inferiority, this apparatus has 3 parts that must be assembled to operate. These defeat the purpose for a convenient, easy to use disposable object. Certainly, this object can not perform for children and elderly.

A series of patents approached oral hygiene by combining a number of means of cleaning into one kit. U.S. Pat. No. 2,527,931 emphasizes a kit of a disposable tooth brush with a bendable handle packaged within a cup that would be sold in vending machines. U.S. Pat. No. 4,384,645 presents another portable kit with a hollow hard handle that contains a toothpaste tube. U.S. Pat. No. 3,646,628 shows yet another kit: this is a square sponge, functioning as a scrubber, held at the sharp tip of a plastic tooth pick. Numerous other patents show novel packaging of dental Floss with tooth brushes or finger worn dental wipes in kits. The scope of this patent is not in novel packaging or development of kits although there is the potential of packaging a constellation of dental and oral cleaning agents with consideration for liquid, paste, crème, powdered or crystalline substances, Floss, gel bleach, resurfacing agent and many more in our single small embodiment, as they pertain to the scope of this oral appliance. However, kit packaging remains unmentioned in this patent without limiting our scope.

U.S. Pat. No. 4,748,709, Jun. 7, 1988, exemplifies a chewable mouth-brush, a tuft of Bristles, connected to a rigid central core. The Bristles drive into the occlusal surfaces of teeth for debris removal. Limitation of this object is the rigidity of the core, forcing Bristles and exogenous particles including bacteria against the dental gum line increasing odds of gingivitis, periodontitis, apical infection/abscess, and calculi, in addition to severe discomfort in chewing a hard substance at its core. Some psychiatrically challenged patients may break teeth or suffer with cracked root syndrome as a result of using such objects.

U.S. Pat. No. D321987 handleless toothbrush Dec. 3, 1991, is a revolutionary ornamental design for a handleless toothbrush, which shows a rigid square embodiment covered with Bristles on both surfaces, a close cousin of U.S. Pat. No. 4,748,709.

U.S. Pat. No. 3,853,412, Dec. 10, 1974, the Tooth Cleaning Ball, is an ingenious design of a chewable plastic or rubbery ball of Bristles and apertures that allow dentifrice to sieve out as a result of chewing. A spherical, resilient, chewable, disposable, object carrying Bristles for use in conjunction with a self-contained, self dispensed dentifrice within its hollow cavity. The principal object of this invention was to provide a tooth cleaning ball which would effectively clean a person's teeth when it is chewed upon. This is the most pertinent patent to date. However, our physical improvements on attaining this mission, plus the special consideration for specific target groups, manufacturing costs, and multiple additional unique scopes sets us apart with a superior functioning, cost effective, versatile, disposable, environmentally friendly object of adornment with insatiable marketing potential.

U.S. Pat. No. 6,769,828 Bristle Anchor, issued Aug. 3, 2004, might seem pertinent. It is a chewable toothbrush consisting of a chewable brush head. As in above mentioned Tooth Cleaning Ball, multitudes of Bristles are connected to a soft shell with a hollow cavity within the embodiment. In Tooth Cleaning Ball, the Bristles are placed in neat rows, while in Bristle Anchor, ideally a dense irregular pattern is specified. Both patents show communicating holes to the inner hollow cavity; both note release of dentifrice, wetting material, or mouth wash from the inner cavity as a result of chewing. However, in Bristle Anchor, the cavity within the article requires an entryway, and a coupler to mate with a dispenser, whereby substances, dentifrice may be injected therein. There is a stem on the Bristle Anchor, that's designed to protect against swallowing, and a lip guard which would protect against lip injury. Its scope of use is both close to the conventional tooth brush that has a handle for guiding the chewable brush head, or the pacifier for use in children. Bristle Anchor has features that render it suboptimal for marketing, besides having a more expensive production cost.

Firstly, it requires the operator to load dentifrice into the cavity, a step that makes it less convenient. While it is configured for both multi-use and a disposable, cleaning an object with an internal cavity may not be hygienically proper. Another feature listed for the Bristle Anchor is means to protect liquid dentifrice from seeping out from its seep-holes. Listed in the specifications is a coat of wax or toothpaste functioning to keep liquid wetting material or mouthwash inside the core cavity. The function of wax or toothpaste is to protect the liquid content of the cavity from seeping out of the article through its seep-holes before its use. Wax maybe used in the outer coating, which would soften with oral temperature and by chewing. Wax may also trap food particles within it as was noted in the specifications.

Suboptimal factors in this well intended idea are: 1. toothpaste is a hydrophilic compound and it dissolves in water based solutions. Hence, the toothpaste covering the seep holes that release liquid wetting material or mouthwash would easily melt away and leek mouthwash or the wetting material through the seep holes. This can not be marketed. If the tooth paste is applied first, then wetting material is injected into the cavity by the special dispenser with the coupler, and then used immediately, it would become less convenient than using a toothbrush. The wax coat might work to keep the wetting material inside the cavity, but after chewing, the wax can break into pieces and stand separate from the watery oral content in particulate form. This would be a suboptimal experience for the user when additional insoluble waxy particles flow within the mouth. Wax particles would add to the insoluble particles in the mouth. Lastly, waxy compounds are not known to collect or chelate food particles or bacteria, unless they are lipophilic, as wax is itself. Powdered Bees Wax has been successful in cleaning oil spills in the ocean. So if it is an oily substance, it might be absorbed by the wax. Manufacturing such article for use becomes pointless, for the inconveniences and the quality of experience.

U.S. Pat. No. 5,921,255 Oral Cleansing Article is a rubbery dental object received as a whole within the mouth, that's manipulated with the tongue to dislodge foreign particles and massage gums. Plurality of protruded members extend out from a spherical core which have distal linear edges for the purpose of scraping particles from teeth, promote salivary excretion, and massage gums. This item does not include the need for any complementary oral cleaning agent. It is a great design with a difficult marketing potential.

Much of the academic research in oral drug delivery systems involve delaying release of an active drug by finding a proper molecule for chelating or conjugation with the said active drug, in which GI digestion and the rate of enzymatic cleavage become the controlling factor. The goal of these conjugates is to provide the means for sustained release of the active molecule. The site of action is the GI tract, and the entire dose is often ingested. Other uncontrollable variables are rate of GI release of enzymes that break free the active ingredient and secondly, the rate of GI absorption. None of the noted variables can be voluntarily and readily be modified. These are limitations of U.S. Pat. No. 7,189,414. There are no mechanical delivery systems with the required safety, versatility, readily modifiable rate of drug delivery, in a miniature package. In our package, the entire dose is not delivered unless the patient makes the mechanical effort. In addition, there are no systems that allow an insitu reaction. An insitu reaction within an embodiment that can be placed in body cavities, or implanted at any surgical site may have amazing potentials implicated in this patent. U.S. Pat. No. 7,074,426 describes an embodiment for drug delivery in orofacial region that is worded with relations, but is clearly intended for intratissue placement, implanting within the tissue and not topical placement.

### OBJECTS AND ADVANTAGES

### List Advantages

There are numerous functional improvements to dental cleaning with this article when compared to using the conventional tooth brush, and what is currently available in the market as disposable single use dental cleaning apparatus.
a. This product excludes the use of finger in mouth which is an invasive procedure for children and elderly or mentally challenged individuals.
b. It has a relatively smaller packaging for carry and travel.
c. It has convenience of use and disposal.
d. This product improves compliance with oral hygiene by elderly, children, mentally retarded, psychiatric patients or other brain disorders causing tremors, ataxia, athetosis, or other disrhythmia, or extrapyramidal symptoms.
e. Hospitals can save by dispensing DMC to patients who are in short stay in hospitals. This package will be less costly than what they provide to all patients currently.
f. It addresses safety issues with prisoners, who are able to make weapons with toothbrush handles.
g. It provides a faster means of adaptation for children to use conventional tooth brushes by first introducing a smaller less invasive item that remains in their control during chewing, as when children experiment with toys.
h. Elderly can enjoy a gum massage after a full day wearing dentures.
i. Adult users find the convenience of use, anywhere outside a lavatory, in a small package, on the plane, before a meeting, after a meal or while walking to their meeting.
j. Airline industry can dispense DMC on airline where security aspects of carrying liquids or pastes on board of planes are essential precautions.
k. Hygienically challenged individuals who live in the streets may find it useful anytime anywhere.
l. It provides a more comprehensive approach to oral hygiene simplified in a single item that is light weight, with added value of saving space in a purse or clothing pocket where real estate may be scarce.
m. This product is designed to trap expectorant into a solid object while conveniently making available all forms of dentifrice for the user.
n. It opens a new way for drug delivery and oral treatments that has never been explored until now.
o. This product can set stage for reactions within its substance (insitu reactions) whereby heat of reaction or gaseous products of the reaction can jet out through its Surface Pores into the mouth.
p. By staging insitu reactions within the mouth, we can open the door to delivering treatments with compounds that have reasonably short half lives.

### DRAWING FIGURES

The term biomolecules is used here to refer to all medical and dental compounds deemed reasonable for use with this embodiment including dentifrice. Descriptions of all drawings assume object position in the oral cavity.

FIG. 1 shows a DMC embodiment in its simplest form. This embodiment is composed of hydrophilic open-cell polymer foam. Liquid dentifrice or fluid may be impregnated within its foamy/spongy structure.

FIG. 2 illustrates a DMC Open System (OS) showing a Pod (a storage unit within the substance of the foam) with a direct opening from the Pod to oral cavity. Pod(s) may contain viscose dentifrice or other significant biomolecules for special chemical reactions. Pod may be lined with a layer of hydrophobic polyol compound or closed-cell polymer.

FIG. 3 illustrates a DMC Closed System (CS) showing a Pod with an indirect opening to the oral cavity. The content of Pod is released into the oral cavity, through conduits connecting Pods to surface, hereafter called Pod Channels.

FIG. 4 shows a cross section of a DMC OS with a different architecture. In this example, a DMC OS is depicted with multitude of Ridges on its side walls for cleaning the buccal surfaces. Numerous Bristle bundles and Pegs on its superior and inferior surfaces are attached to a High Density Layer. These are used for interactions with the roof of mouth, tongue, dental and gum for scaling, cleaning and massage. Open Pod is depicted in its center.

FIG. 5 shows a DMC CS with one centrally located Pod, not shown. Multitude of Surface Pores is featured on the superior aspect, and please imagine the same for the inferior aspect. Multitude of Ridges seem to shuffle among the rows of Surface Pores on the High Density Layers as well. In this example, the side walls of this embodiment show a Groove, to expose more open cells of this foamy embodiment, not shown, on its lateral surfaces. Broken line with arrows on its distal ends show the cross sectional cut that will expose the internal structures of this sample in FIG. 6.

FIG. 6 shows a cross sectional cut of a DMC CS depicted in FIG. 5. The High Density Layer shows multitude of Surface Pores and Ridges. Below each Surface Pore we see the conduit that connect the central Pod to the Surface Pore called Pod Channel. Pod Channels span the girth of the surrounding Hydrophilic Open Cell foam. Surface Pores regulate the flow of Pod's content extrusion by the size of their opening.

FIG. 7 shows a DMC with multitude of Bristles; it is shaped in the form of a sphere, and attached to it, we see a Tassel or Floss.

FIG. 8 shows a DMC in the shape of a soccer ball. Surface Grooves are depicted in black lines and pentagons. Grooves can take geometric shapes, just as the High Density Layers may take any shape. White hexagons are flat, linear, sheet of a High Density Layers without surface features. A Tassel or Floss is connected.

FIG. 9 shows a DMC fashioned in the shape of a basketball. Surface Grooves are in thick black lines. Grooves may take geometric shapes or form curvilinear lines on the surface of a DMC. Attached is a safety mechanism against swallowing, Tassel or Floss, connected by means of attachment.

FIG. 10 shows an alternative embodiment of a DMC that is in the shape of a gummy bear. The Tassel is attached here too.

FIG. 11 shows a DMC CS bisected transversely. Acting as a miniature laboratory with two Pods; Pod A overriding Pod B, each would contain active ingredients for a reaction. Pod Lining protects against Pod content to sieve into the surrounding Hydrophilic Open Cell substance of the embodiment. A polyol Brittle Shield that breaks with small enough force is sandwiched between the thin enough Linings of the two Pods. Upon chewing and breaking of the polyol Brittle Shield, the contents of Pod A and B intermarry for a proper reaction inside the embodiment. This reaction is described as an insitu reaction. The product of said reaction is channeled out via Pod Channels.

FIG. 12 is a quarter section of DMC CS shown in FIG. 11. The Hydrophilic Open Cell foam surrounding the Pods is stripped away. Portion of the roof of Pod A is removed. The Brittle Shield is sandwiched between the Pod Linings of Pods A and B that are shown translucently. You can see the Brittle Shield is made brittle, by means of scoring, shearing, stippling or etching. Where Pod Lining comes in contact with the Brittle Shield, they fuse by means of fusing. Hence, the broken Brittle Shield pierces through the Pod Lining of Pods A and B, allowing the reaction to take place between reactants within the halls of the Pods. The product of the reaction will gradually flow out through the Pod Channels and Surface Pores into the body cavity in which the DMC is placed.

FIG. 13 shows a cartridge comprising of a Brittle Shield separating two reactants, R1 and R2, blanketed by a layer of translucent closed cell polymer, better known as Pod Lining. The Pod Lining forms two pockets against the Brittle Shield, on each side. To reiterate, what separates the two reactants is only the Brittle Shield. The Pod Lining is fused to the Shield at its four edges to form the pockets for the two reactants.

FIG. 14 shows a 4 reactant system (4R) in a cluster. Encapsulated by one Pod Lining, the Brittle Shield, in chair configuration can separate up to four reactants within the one enclosure. By chewing on the DMC that houses this cartridge, and breaking the Brittle Shield, the reaction products are formed and may extrude through Surface Pores or burst through weak points fabricated within the Pod Lining into its DMC jacket.

FIG. 15 is a DMC CS transversely spliced at one end to show a cylindrically drawn capsule within its central Pod. This model conducts a single note symphony of reaction and extrusion at the same time. The capsule, shown intact within a Pod, is also made of a brittle polyol compound, shielding one reactant within itself. Once the DMC is chewed, the said Brittle Capsule is crushed by a reasonably small pressure of jaw. The active ingredient within the capsule intermixes with a second reactant in the Pod, which bath the outsides of the Brittle Capsule. A proper chemical reaction would commence, and products would enter the oral cavity through the Pod Channels. Product flow would be regulated by the Surface Pores.

FIG. 16 shows an alternate embodiment of our DMC CS with 4 Wings that dynamically move in a unique way to brush the medial and lateral aspects of teeth during chewing. The 4 spinning arrows show a translation of force F1, which is a function of opposing action of the jaw, into 4 whirling torques within the embodiment of the foam, directing the Wings and their attached Bristles to fold toward their respective teeth. The action of the already angulated Bristles shown in the diagram against teeth can be imagined. Chewing would translate into automatic brushing and poking of occlusal margins of neighboring teeth, in both medial and lateral walls. This drawing also shows 4 Pods, Surface Pores, Angled Bristles, and Ridges. The Pods' outline, drawn in broken lines, are shown on the frontal view, peripherally positioned under each row of Surface Pores, laden within each Wing. Pod Channels are not shown.

FIG. 17 shows a DMC designed to provide increase safety, increased efficacy, and shortened time for results in UV-light tooth whitening systems. It shows two rows of Fiberoptic Strands built within the substance of the embodiment traveling through its core, and arriving at the base of each of the Bristle bundles. Blue light or UV light travel through the Fiberoptic Strands and exit near the base of Bristles. This figure shows a combination of brushing and brightening technique while chewing. Chewing brings about functional dynamic shape changes in the Wings and their attached angulated Bristles, which in-turn become carriers of the light projecting the light onto teeth surface.

FIG. 18 shows an alternate DMC with Fiberoptic Strands attached to the side walls by means of attachment, where they dip into the substance of the foam at the distal end of each Wing, exiting at an angle similar to the angle of Bristles seen in FIG. 17, pointing the light to the teeth and gingival margins where plaques and biofilm develop. A relatively High Density Layer is shown, embedded within the substance of the foam. The High Density Layer assists the functional dynamic shape change that moves the Wings and the Fiberoptic Strands to clamp against teeth on both medial and lateral surfaces of the teeth. The direct exposure of light to the teeth, and minimized dispersion of UV light that is harmful to the mucosal surfaces clearly shows a novel mechanism of distributing UV light to teeth for the purpose of whitening teeth. Our DMC would make this procedure more efficacious, safer, and can generate results in a shorter time.

Reference Numerals in Drawings

| | |
|---|---|
| 10. | Pod |
| 12. | Pod lining |
| 16. | Hydrophilic Open Cells |
| 20. | Pod Opening |
| 22. | Pod Channel |
| 24. | Surface Pore |
| 26. | High Density Layer |
| 32. | Bristles |
| 34. | Peg |
| 36. | Ridge |
| 38. | Groove |
| 40. | Tassel or Floss |
| 50. | Wing |
| 60. | Fiberoptic Strand |
| 80. | Brittle Shield |
| 82. | Brittle Capsule |

### DESCRIPTION

### Main Embodiment

A reasonably soft chewable embodiment made of a polymeric open cell (or in combination with closed cell polymers), hydrophilic foam (or combined with hydrophobic foam), that returns to its original fabricated shape after mastication, storing a variety of biomolecules for oral administration. It may have multitude of surface features and embedded features for special functions. While being chewed like a chewing gum, the integrity of its fabricated architecture, shape and function will remain intact, unlike a chewing gum that loses shape and partial function. Favorable qualities worked into manufacturing this embodiment may include hypoallergenic, biodegradable, renewable source. Examples of useful polymers to fabricate this embodiment include polyurethane, polyester, rubber, vinyl, polyvinyl chloride, silicone, cellulose, neoprene, latex, polyethylene, polypropylene, etc. and their combination. One good example of such polymer is obtained from liquid waste paper using polyhydric alcohols to prepare biodegradable polyurethane foam. Other preferred examples are liquefied wood, wheat straw or starch-based polyols which disintegrate by wood fungus in approximately 1 month. Injection molding properly shapes this embodiment, but by no means limits the manufacturing intricacies or limits the scope of manufacturing this embodiment known to people in the arts.

Open cell polymers form foam with architecture similar to open scaffolding, or lattice like, as opposed to the closed cell polymers that form closed walls in a foam. Foams made with open cell polymers can easily absorb and release fluids, while a closed cell polymer may wall off content, and be best used as a barrier. Considering the number of hygienic and medically related compounds used for human and animal health, which are mostly water based or water soluble, it behooves the industry to select a Hydrophilic Open Cell polymer to fashion this embodiment, because it adds to the storage capacity of this embodiment. In other words, a larger volume of fluids and water soluble compounds may be carried by such embodiment. The molecular architecture of this foam also allows capture and trapping of reasonably small sized particles, microbes and debris that might be flowing with oral fluids into the foam.

A common scenario that plays out by chewing this embodiment is first, release of dentifrice in the oral cavity, followed by dislodging of bacteria, biofilm, plaques and debris, followed by reabsorption of the fluids by the open cells, and trapping of the small particles. Finally a solid object laden with fluid, bacteria and particles may be expectorated. Isn't it more proper to remove a solid object from our mouth, than to release a flood of liquid expectorant? This may be a good thing especially when we are on the go, outside of a lavatory. The micro features of DMC produce fantastic macro results in oral hygiene.

Polymer sciences will define some versions of this embodiment, as they define various consistency and resilience, absorption and secretion rate of this embodiment. This spongy chewable embodiment may be fashioned in any shape that can fit in a mouth and be chewed comfortably by mouth. They can be fashion in any color or color combinations. The scope of this invention is further illustrated as we list its characteristics at a macro level. Let's include some surface features, and embedded features and explore the ways this article may be used.

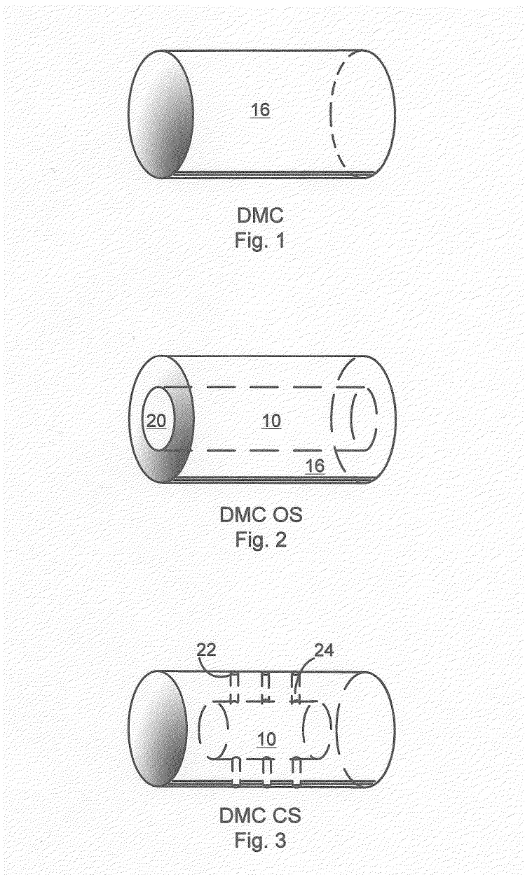

A simple embodiment of the present invention is illustrated in pictures FIG. 1 showing a basic embodiment with no surface features or embedded features. The first macro characteristic of this embodiment is to define it as an open system vs. a closed system embodiment. FIG. 2 shows an open system (OS), while FIG. 3 shows a closed system (CS). Open system (OS) refers to a direct opening #20 from the Pod #10 into the oral cavity. A Pod is a storage unit embedded within the substance of the foam; in closed system (CS), the Pod is connected to the oral cavity indirectly, via Pod Channels #22, which are conduits to the Surface Pores #24. Surface Pores can regulate flow of the predetermined biomolecules stored within the Pod. The uses of OS and CS will come to light depending on the DMC application. However, for now, let's simplify our mental picture in some tangible example: let's imagine a DMC OS used for basic oral hygiene, and imagine the DMC CS used for drug delivery and delayed release of predetermined stored biomolecules. OS vs. CS are the first of uniquely divergent characteristics of this embodiment.

Earlier, we differentiate hydrophilic nature of the polymer used in production of the foam, and the hydrophobic nature of polymers that may be used to act as barriers. The Lining of Pods #12 (Pod Lining) and Pod Channels may be hydrophobic or a closed cell polymer, e.g. polyethylene. So the unique perspective here is that for the most part a DMC is made up of Hydrophilic Open Cell polymers which holds low viscosity liquid dentifrice well, while the Pod(s) #10 may house a more viscous dentifrice, such as crème, gel, paste, powder or crystal dentifrice, that is walled off from seeping into surrounding open cell substance. The scope of this patent doesn't limit what active ingredient may be impregnated into the open cells or encapsulated within Pods in this embodiment.

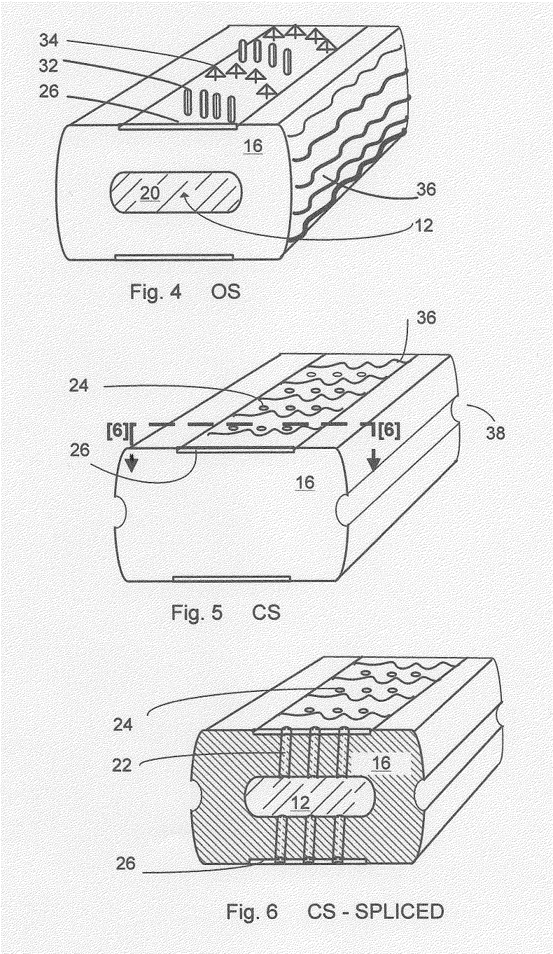

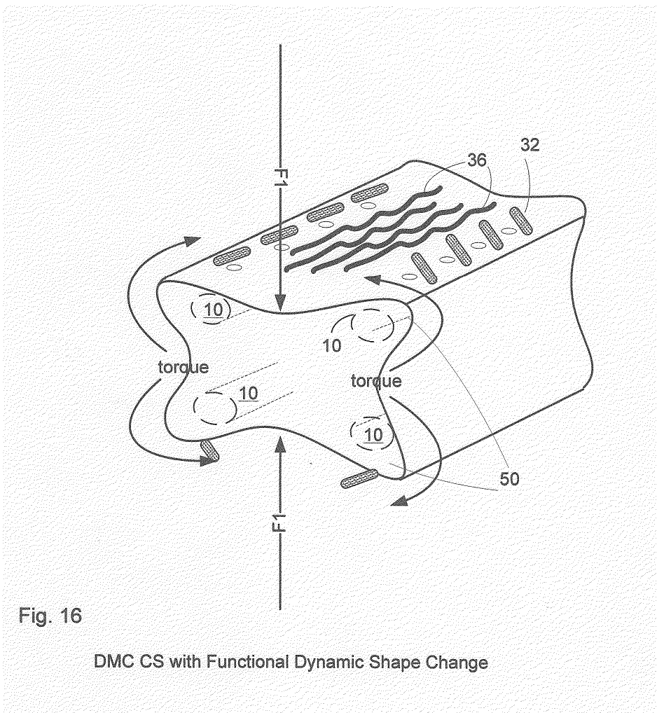

There are numerous surface features on this embodiment. In the drawings #26 is named the High Density Layer, which is a relative term, shown in FIG. 4, 5, 6, 8, 9, 18. It would be more descriptive to say that our polymer can have variable densities during injection molding, so the High Density Layer is best described in terms of the injection of the variable density polymer used for this embodiment. Variable densities can define resilience, rebound, and resistance of the foam. Relatively speaking, High Density Layer #26 can give support to the shape of the foam, shown in FIG. 4, 5, 6 and FIG. 8, 9. Here High Density Layer is a surface feature. In another instance FIG. 16, High Density Layer can assist in making functional dynamic shape changes, and here it is an embedded feature. A functional dynamic shape change in our DMC is a unique feature that's explained in alternative embodiment section. High Density Layer #26 in FIG. 4, 5, 6 may anchor numerous surface features, including bundles of directionally sorted polar Bristles, Pegs, and Ridges by means of attachment. In another instance, some of the surface features may be fabricated using variable density polymer during injection. In another instance, hydrophobic polymers, or closed cell polymers may be used to fashion the surface features. This patent doesn't limit the scope of the chemical structure used in forming specialized surface features or their mode of attachment to our DMC.

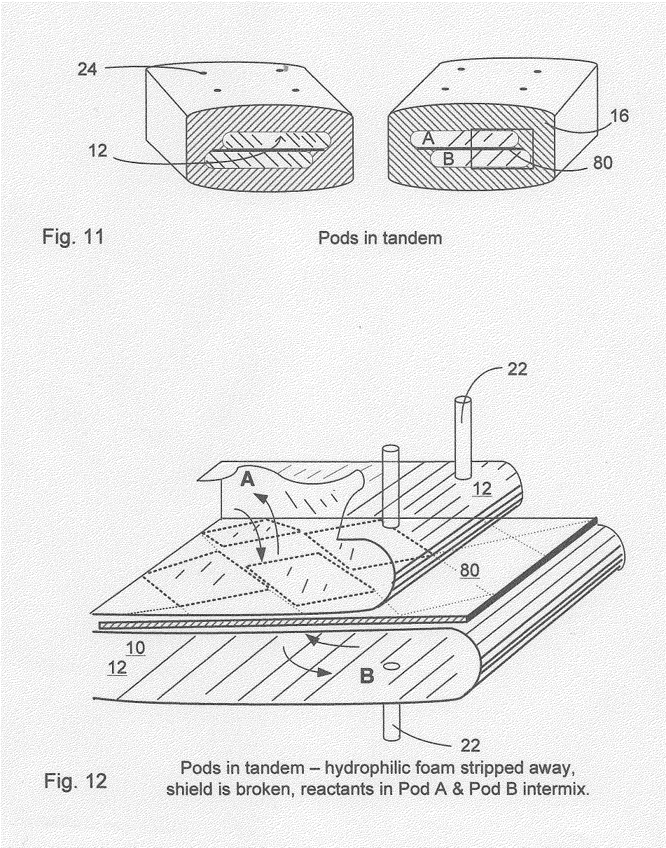

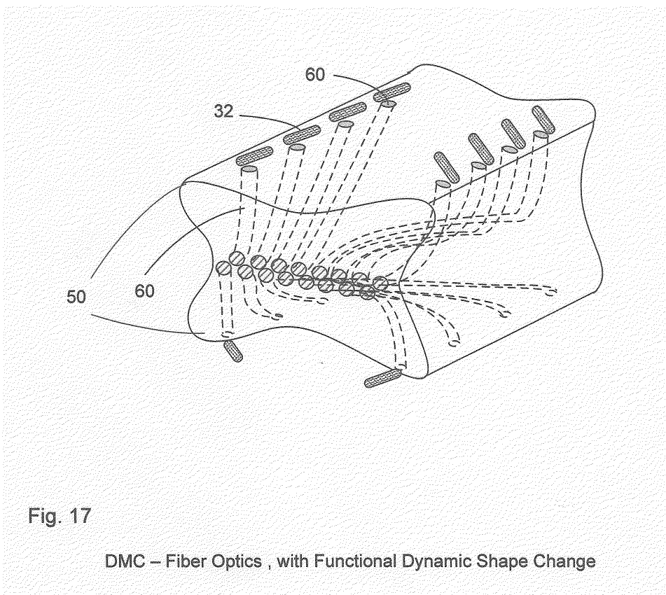

The multitude of surface features on our embodiment relish specialty functions. One breaks off stuck-on food, another brushes off smaller particles, still another gives a soft massage, and yet another shunts fluids inside the oral cavity. More surface feature can be seen in the alternate embodiment section, below. FIGS. 4, 5, 6, 7, 16 and 17 show bundles of Bristles #32 for brushing. FIGS. 16 and 17 show sufficiently angled Bristles. These are angled, polar, directionally sorted bundle of Bristles, as opposed to a random chaotic tuft of Bristles; they are transparent with reasonable capacity to transmit light. It works in conjunction with another unique feature of this embodiment, Wing #50, which is involved in functional dynamic shape changes, described in alternative embodiment section. Pods #10 in FIG. 11, 12, 13, 14, 15, 16, have variable number, position, shape, and fabrications that evolve in definition in next paragraphs. Pegs #34 poke and scale surface-anatomy of molar and premolar teeth and their occlusal edges, where food particles often stick. Ridges #36, positioned peripherally, on the embodiment scrub and massage all oral surfaces; for example by contact with buccal mucosa, gums, tongue, roof of mouth, best shown in FIGS. 4 and 5. Elderly deserve a good feel oral pampering after a full day of wearing dentures using a DMC with peripheral Ridges.

Grooves #38 placed peripherally on the embodiment function to increase the overall surface area, see FIG. 5, 6, 8, 9. More surface area improves the rate of release of dentifrice or other biomolecules impregnated within the Hydrophilic Open Cells, upon chewing. By the same token, Grooves help reabsorption of oral fluids and particles back into the substance of the spongy foam. Grooves shunt fluids out from this embodiment, and can shunt fluid back into the embodiment, to the available open cells that are available to absorb fluid and particles.

One of the embedded features of this embodiment is Pod #10 previously mentioned. It is a hollow cavity that can store and protect various compounds from early release. This definition for Pod must suffice for now, but it evolves drastically in the next paragraphs. Pod Lining #12 is a hydrophobic polymer or closed cell polymer, which lines Pods and Pod Channels #22. Pods encapsulate biomolecules, which require delayed or regulated release through the Surface Pores #24. Pods content may be a compound with a relatively higher viscosity. An example of what might be encapsulated within a Pod is dentifrice in cream, gel, paste, powder or crystalline form. Chewing would gradually allow extrusion of Pod content by pressure. This patent does not limit what compound might be stored within a Pod, or their quotient of viscosity.

Pods unique function within this embodiment brings about a quality that has never been described about any mechanical object for human health to date: an embodiment that has the capacity to carry an insitu reaction while sitting or traveling in a human body cavity. A miniature laboratory set that can propagate a chemical reaction while visiting a part of human body. In this case, we are using this embodiment in the mouth. It can contain multitude of active ingredients, or reactive molecules if you will, or chemical processes that can be mechanically initiated at will. Our models in FIGS. 11 and 12 lend themselves well to describing a simplified version of a reaction process with special results tangible for what a Disposable Mouth Chip, DMC, can provide to oral hygiene without placing limitations on the scope of usage of this embodiment in other cavities. So we are describing an embodiment that gives reliable control to onset of a reaction and delivery of a product to a reasonable site without the need for its ingestion. We are describing the smallest untethered embodiment that can produce and deliver, for example heat, gas, or jet pressure within a cavity. The list of reactions within this embodiment, or place of its use, is not made limited by this description.

A block shaped embodiment is transversely cut in FIG. 11 showing two Pods marked “A,” which overrides Pod “B.” A Shield #80 made of a brittle polyol, which is easily breakable, is sandwiched between the two Pods. Intended reactants are stored within the said Pods. The small enough pressure by teeth on to the Shield, induced during jaw closure, breaks the Shield and the content of the two Pods intermix. A known final product is produced by the reaction within the Pod structures, now in a continuum. The final product will then enter oral cavity via Pod Channels, during chewing. Surface Pores #24 regulate the flow of extrusion from Pods by the size of their opening, and presence or absence of valve leaflets. Our interest in the product of a reaction may be simply the heat of reaction, safe biological gases, or pressurized jet flow from the embodiment.

It is important to take a step further to define Pods more accurately. It is not a punched out space within the Hydrophilic Open Cell foam, but it is the confined space created by at least one layer of closed cell polymer, or in combination with at least one layer of polyol Brittle Shield #80. This concept is described further. The Pods designs for insitu reaction are too numerous for show, but its numerous design ingenuity are within the scope of this patent.

FIG. 12 is an expanded view of the core of a DMC pictured in a box area in FIG. 11. FIG. 12 is a longitudinal bisection of a transversely bisected DMC shown in FIG. 11. In addition, the surrounding Hydrophilic Open Cell foam has been stripped away. We can demonstrate two offset Pods “A and B” with a Brittle Shield #80 sandwiched in between them. Note each Pod in FIG. 12 is lined by Pod Lining completely, and where the Pod Lining comes to contact with Brittle Shield, they fuse by means of attachment. Furthermore, the force that breaks a Brittle Shield will force it to pierce through the Pod Lining as well. In FIG. 12 a portion of the top translucent Pod Lining #12 was removed to illustrate the floor of Pod-A, broken by an external force; chewing breaks the Brittle Shield #80, which pierces the Pod Lining. The arrows show the intercommunication of Pod A and B, whereby the marriage of their content would create the desirable reaction.

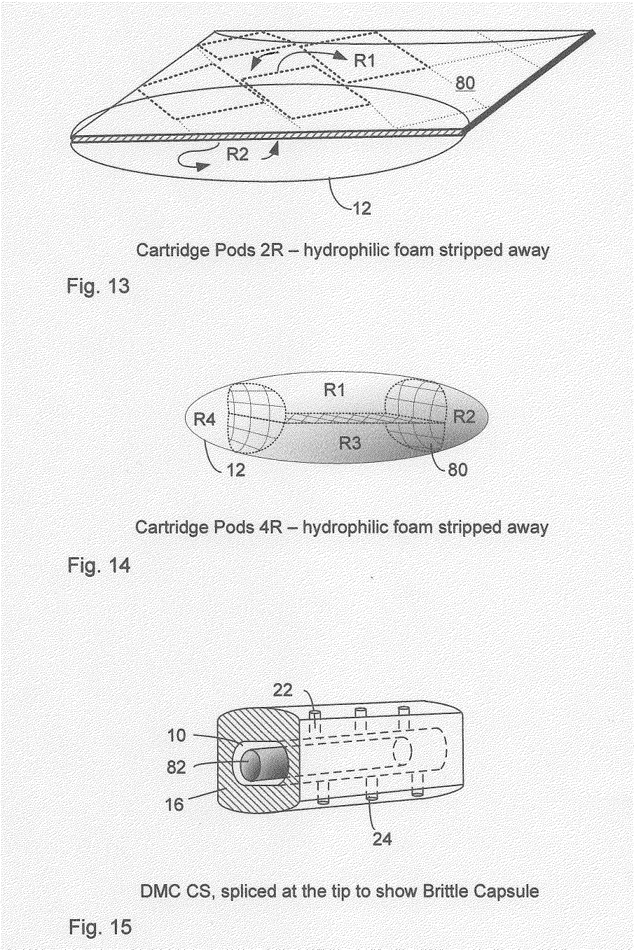

FIGS. 13 and 14 illustrates Pods' diverse anatomy in 2 and 4 reactant systems. They also show a method of manufacturing Pods for insitu reactions in cartridge format. FIG. 13 shows a cartridge comprising of a Brittle Shield #80 separating two reactants, R1 and R2, blanketed by a layer of translucent closed cell polymer, or hydrophobic polymer, previously noted as the Pod Lining #12. In FIG. 13 Pod Lining forms two pockets against the Shield #80, on each side. What separates the two reactants is only the girth of Brittle Shield. A top Pod Lining and a bottom Pod Lining are fused to the Shield at its circumferential edges to form two pockets for the two reactants above and below the Brittle Shield. The three layers are fused by means of adhesion. Plasma etching and acid etching are useful in preparing the edges for adhesion. Injection of each reactant or biomolecules intended for each pocket may use a Teflon coated nozzle for easy withdrawal just before the final closure of each pod. The intricacy of methods in manufacturing Pods is subject of other patents. However, they are within the scope of this patent.

FIG. 14 shows a 4-Pod-cluster separated by 3 Brittle Shields interconnected to compose a chair configuration, separating 4 Pods, ensheathed by one elliptic Pod Lining #12. This cluster cartridge of 4 Pods is then placed in a reasonably dimensioned DMC jacket small enough for chewing. Two points to clarify is one, Pod clusters may be as shapely as a honey comb, and two, a DMC jacket can be defined as a cluster of elements that constitute a DMC not including Pods and Pod Lining; i.e. Hydrophilic Open Cell polymer, and combined polymers used to fashion High Density Layer and other surface features. Method of manufacturing Pods in cluster or in tandem, in cartridge inserts for DMC jackets and their alternative versions are within the scope of this patent. The scope of this patent does not limit Pods' design ingenuity.

In another embodiment, FIG. 15, a DMC CS has one end transected to show a cylinder-like Brittle Capsule #82, made of similar brittle polyol polymer as the shield #80. Brittle Capsule protects one reactant therein, floats freely bathing within a second reactant inside the Pod. In this example, one Pod Lining #12 might encase one reactant and the Brittle Capsule #82 encases another reactant. By chewing on this DMC CS, the marriage of the reactants and reaction results can debut in the mouth almost immediately.

Having seen one Brittle Capsule within a Pod, it would be a short leap to see a multitude of reasonably smaller Brittle Capsules placed in a Pod Lining for a predetermined reaction. A multi-reactant DMC, having reactants housed within Brittle Capsules is another novel approach to a miniature micro laboratory. Should a subtle force break the Brittle Capsule, the intended reaction starts off.

A point of importance about a polyol Brittle Shield #80 or Capsule #82 is its making. Beyond choosing a polymer with a brittle quality at room temperature, the ultra-structure of the Brittle Shield and Capsule is prepped by means of shearing, scoring, stippling, or etching. The Brittle Shield and Brittle Capsule are designed for breakage with minimal force.

Once the integrity of the Brittle Shield #80 or the Brittle Capsule #82 is lost, the reactants are released for intermixing, thence the intended chemical reaction takes place and the final product is then extruded from Pod Channels. The goal of insitu chemical reactions within an embodiment can include a variety of therapeutic molecules with important considerations for those products that have reasonably short half life. So, the scope of this patent will include a method of drug delivery via insitu chemical reaction, generating heat, pressure, and jets, or a product with a reasonably short half life within an oral apparatus. This scope takes into account the need to deliver supplemental cleaning power into the oral cavity, especially for plaque and biofilm removal. Providing heat, jet pressure, and gas are novel to oral hygiene, as is Oral DMC.

A DMC with the capacity for insitu reactions, may be a tool of choice for esophageal thrush of AIDS patients, whereby delivery of an antifungal to the surface of the lower esophagus may be performed by a DMC; sent down into the esophagus to leave a coat of medication. Antifungals are known to cause liver damage, and delivery of limited treatment directly to the affected area may reduce the amount of antifungals used for treatment. Tassel #40 may be used to guide it back out of the esophagus. While DMC is not digestible, they may pass though gastrointestinal tract uneventfully.

A pediatric Cefadroxil fun-pack may be a good application for a Gummy Bear DMC or a Basket Ball DMC. Here the child is not forced to swallow a pill or an unfamiliar concoction from a spoon or cup. The list of pharmacologic applications are too numerous to note, but are within the scope of this patent. Alternative uses may be using a two Pod DMC, a crystalline antibiotic (e.g. Ceftriaxone) may be first dissolved by a solvent (e.g. saline) in another Pod before delivery to a cavity, given the fact that it is a bad combination for oral use and it is normally administered intravenously. This would be a new application for the drug as topical use via a DMC. For topical antibiotic, or topical steroids uses, a DMC placed in a wound or cavity, such as treatment of hemorrhoids, or vaginal trauma may prove beneficial for course of treatment and outcome.

Consider this embodiment for delivering medications that are abused by adolescents when they are dispensed in pill or tablet form. For example, Ritalin and Adderall, amphetamine class, may be produced in a viscose format for delayed release, enclosed within a Pod. This way the drugs are not readily available for crushing and snorting. It is a novel form of delivering medications that are commonly abused by the youth, especially those prescribed for ADHD.

Pain medications for visceral pain, morphine class, are sometimes given to hospital in-patients to self administer. A dispenser device, IV depot, and a clicker is given to the patient to self administer the medication. DMC is useful when a physician can give control to the patient to self administer a medication. Drug release into a patient's mouth would be directly proportional to how fast a patient may chew or how hard a patient may bite on a DMC. This approach will prove cheaper for hospitals, and more convenient and versatile for patients. The savings would include a factor of the cost of the machines and staff involved in their setup and maintenance. The scope of this patent does not limit the types of medications that may be produced and dispensed in DMC version.

A relative comparison of delayed release system for drugs administered in a pill format and a DMC format may bring to light the benefits of using a DMC version. Delayed release pills with conjugated ingredients must first be digested in some portion of GI tract before they are absorbed. Depending on the conjugate, a length of time is required before the entire dose is absorbed by GI tract. However, this mandates the intake of the entire pill and the entire dose. In the DMC version, the control and delivery is in the mouth, and the complete dose will not have to be ingested in its entirety.

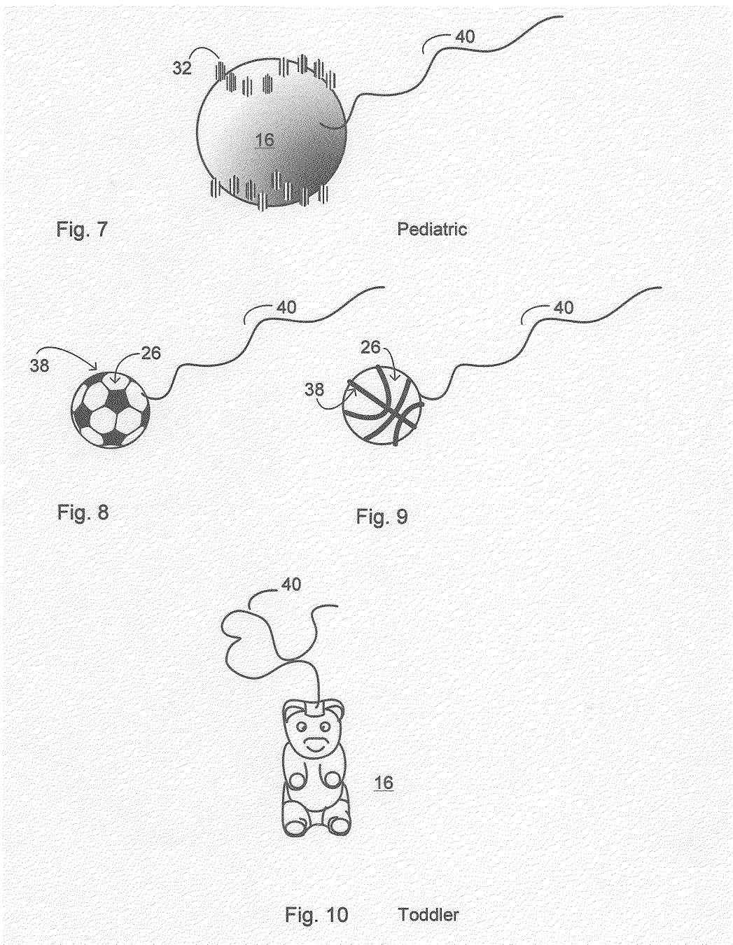

FIGS. 7, 8, 9 and 10 Tassel or Floss #40 is a novel safety mechanism that helps control our DMC from being swallowed. A caretaker for children, elderly, patients with psychiatric challenges or patients with extrapyramidal movement disorders will find this tool useful. Consider one of the not so novel uses for Tassel or Floss, which is to dislodge large particles from occlusal spaces between neighboring teeth.

Note that in all instances where manual dexterity is jeopardized, a DMC is a complete and effective article for oral hygiene. Despite most damage to cortical brain and loss of physical function, chewing is among the last functions lost. Therefore, a DMC may be the best defense for oral hygiene in those with severe physical dysfunction due to brain damage.

Hospitals give costly hygiene kits to their patients during their stay. A large number of patients don't use these kits, which may include a tube of tooth paste, a disposable tooth brush, a bottle of mouth rinse, and a kidney bowl. Hence these expensive kits are discarded. This waste may be minimized if a cheaper, more convenient product is offered for patients to use. Not only the cost for patient oral hygiene will drop for the hospitals, it is likely that the patient compliance may improve since it is convenient, requires minimal effort, may be used in bed, and the expectorant is a solid product, as opposed to a volume of oral fluids that might course its way down a patients face and neck.

Airline safety has become an issue and there have been mandates to avoid allowing passengers to carry liquid or paste, including hygiene material on board of planes. This, however, has not quelled passengers need for good oral hygiene while traveling. This embodiment can generate cash flow for the airline industry, while providing a neat solution for passengers that could enjoy a mouth wash, fresh breath, clean teeth, oral massage, with no mess, while seated on their seat.

Safety has been a core concern in the prison system. Tooth brush handles have been used by prison inmates to make sharp object for stabbing. This embodiment will provide a safe and complete solution to oral hygiene for our prison inmates without an item that can be fashioned into a weapon.

We often see children explore objects by their mouth. They place things in their mouth before they begin teething. There is no evidence that an element of early learning maybe their oral explorations, though we find similar behaviors in young animals such as dogs or cats. However, this may be an excellent route to start children training for acceptance of objects with Bristles in their mouth, by allowing them to explore a foamy embodiment with diverse surface features, including Bristles. This is an object that they place in their mouth, and they manipulate as they please. It is not as invasive as placing an adult finger in their mouth, with a condom brush at the tip. The chemical structure allows for a diversity of shape and colors that are appealing.

The ideal that one apparatus should have liquid dentifrice, a pasty or crystalline dentifrice, a bleaching agent, and a resurfacing agent, and should be convenient, small in size, disposable, environmentally friendly, fun to use, and have the disposition to offer additional custom features for cleaning power or medication delivery is the reason for this embodiment. If not for convenience of use alone for the people on the go, outside of a lavatory, before a meeting, this embodiment was conjured for military personnel, hospitals, prisons, international traveler, and children, elderly, physical or mentally disabled folks with an oomph for better compliance.

### Operation

### Main Embodiment

Chew it like a gum and it massages, cleans, and secretes embedded material, and after a few good squeezes between the teeth, it reabsorbs, the fluid, traps particles and bacteria. The solid expectorant will contain fluids, bacteria and particle. Clients would be far more inclined to expectorate a solid object from their mouth, than a turbulent flow of fluid that spray and ungracefully course down ones face.

### Description and Operation

### Alternative Embodiment

The alternate embodiments can take any shape or color that might create appeal; alternatively it might have physical attributes that would improve functionality. The function of this embodiment is oral hygiene, special dental treatments and drug delivery. Examples of shapes and colors that create better appeal for target groups is illustrated in FIGS. 7, 8, 9 and 10. This patent does not limit the scope of designs and colors that can be used for marketing this product: i.e. one design might look like a gummy bear FIG. 10, another might be a sphere that's imprinted to look like a small football or basket ball FIG. 8, 9, or still another might take the shape of a favorite children's toy or cartoon, like Sponge Bob. FIG. 7 is a spherical version with Bristles. The multitude of surface features and embedded features, functional dynamic architecture resulting in automatic brushing, insitu reaction, drug delivery, and solid expectorant can produce limitless designs in alternate embodiments. This patent does not limit the combination of features that may be used on this embodiment.

Functional dynamic shape changes, introduced earlier in FIG. 16, can be seen in a simple diagram with a star-like, winged, design. The architectural designs may be very complex and the polymers or element used to define specific movement, or assisted movements, within the embodiment are within the scope of this patent. In the Winged diagrams in FIGS. 16, 17 and 18, forces (F1) produced by temporomandibular joint (TMJ) during mastication is translated to spinning forces, or torques (shown by curved arrows in, FIG. 16, 18) within the embodiment, which would cause functional rotations in the Wings #50. The dynamics of the Wing as well as the angle of Bristles #32 will dictate movement of Bristles against the enamel or gum. The resulting shape change would impact brushing of teeth and gums and occlusal margins. It would be a form of automatic brushing if you will while chewing.

The straight arrows seen in FIG. 16 show the force placed on this embodiment by the jaw as it clamps down on the embodiment. This linear force spins within the scaffolding structure of the foam, translating it into opposing spinning forces, previously named as torques, within each quadrant of this embodiment. The Wings turn inward to clamp horizontally against the teeth as jaw clamps into the embodiment, FIGS. 16, 17 and 18. In other words, vertical clampdown by the jaw translates to horizontal clampdown of the teeth by the embodiment. In this concerted movement, angled Bristles will poke occlusal dental margins, dental spaces, as well as gingival margins to dislodge bacteria, biofilm, stuck on particles and help scale plaques. In summary, spinning forces generated by chewing forces, help us brush automatically.

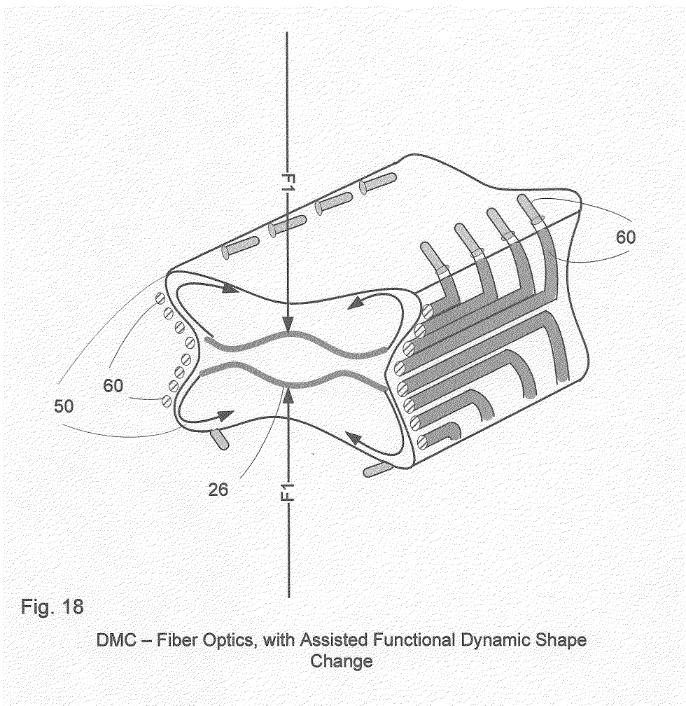

Earlier we introduced High Density Layer (HDL) #26 as the relative term describing the variable density of injected polymer. We described its quality in forming surface features, supporting shape of the embodiment, functioning as a support base for means of attachment to connect surface features to the embodiment. In FIG. 18 we see it assist in functional dynamic shape changes of DMC. As jaw clamps down on the embodiment, side walls of the embodiment are pushed out laterally, proportional to the lateral displacement of HDL #26, within the embodiment. Length and design of HDL within this embodiment is not limited by what is depicted and is dependent on the DMC architecture, polymers used, and other assist elements that the design may require.

FIGS. 17 and 18 show Fiberoptic Strands #60 that carry blue light and UV light directly to the teeth to target plaques, biofilm and stains. This novel approach minimizes the exposure of harmful UV rays to oral mucosa, while directing the blue/UV rays to the necessary sites, where plaques form, near the gum line and occlusal margins. The therapeutic wavelength of light in the visible or invisible range is not a limitation on the scope of this embodiment. Post surgical therapy of gums with infrared light may prove to be effective means of increasing circulation, production of granulation tissue, and acceleration of healing. DMC fiberoptic strands are positioned properly for delivery of said light to gums post surgery.

Light from an optoelectric module is transmitted through Fiberoptic Strands, having coursed the distance from the optoelectric light module to the anterior face of the foam, traveling through its embodiment, as shown in FIG. 17, or stuck to lateral aspect of the embodiment by means of attachment, as shown in FIG. 18, piercing through the lateral aspect of Wings, to surface above to superior surface, and below to inferior surface, sprouting through to a distance short enough to deliver said light to teeth directly, as shown in FIG. 18, or sprouting through to surface and project light through bundles of angled clear Bristles, planted near by, FIG. 17, thereby providing light with each brush stroke of Bristles against dentine, gum line, interocclusal surfaces, margins, dental sulci where plaques and biofilm form.

### CONCLUSION

### Summary, Ramification, and Scope

Accordingly, the reader will see that DMC is a superior product in convenience of use. It serves children as a teaching tool to adapt to bristled objects in their mouth while playing, and exploring an object in their mouth that automatically cleans their oral cavity. It serves the psychosocially challenged individuals with an object of oral hygiene that improves their compliance. It gives independence to the user, and requires no adult assistance, and minimizes nurse supervision. It serves the elderly population with a massage article of the mouth after a full day of wearing dentures. It serves the day users with a conveniently packaged item that cleans and freshens with diversity of dentifrice and features in one embodiment. It leaves the mouth as a solid object, as opposed to the conventional stream of liquid. Its novel Tassel/Floss protects against swallowing while it serves to clean occlusal margins, surfaces and spaces in between teeth. It provides a novel way for delivery of controlled substances, drugs abused by adolescents. It provides novel ways to deliver heat, gas, and jets inside the mouth for added power against plaques and biofilm. It serves dentifrice manufacturers a novel way to market more of their product. It provides unlimited appealing shapes which encourages oral hygiene among all target populations. It saves on marketing expenses for companies who use dental products for marketing. It saves money for hospitality sector that provide dental and oral hygiene products to their clients. It spurs retail business for the airline industry and satisfies a great need for passengers on board of planes for a neat object of oral hygiene that require no lavatory. It saves lives in prison system. While providing a complete system of oral hygiene, it eliminates an element of hazard for inmate population. It provides a complete system of oral hygiene to our military personnel serving abroad.

It starts a new economy, creates new jobs and factories. Thus the scope of the invention should be determined by the appended claims and their legal equivalents, rather than by examples given. Aggrandizement of this patent with its entire scope must benefit people of United States.

I claim: A Disposable Oral Hygiene Article

1. An embodiment for oral hygiene, small enough for chewing, comprising:
(a) a foam substance made of polymers
(b) with a chemical structure selected from the group including hydrophilic, open cell architecture, or in combination with closed cell architecture,
whereby said foam orchestrate functions selected from a list including dispensing of biomolecules, dislodging particles, reabsorbing oral fluids, trapping particles, producing a solid expectorant, conducting insitu reactions, conducting optoelectric rays.

2. A foam composition as claim 1 comprised of:
features selected from the group including dentifrice, bristle, ridge, peg, groove, pod, pod channel, surface pore, fiberoptic strands, polyol brittle shield, polyol brittle capsule, variable density polymer of high density layer, tassel or floss, medically significant molecules, and reactants;
whereby said foam and at least one to a plurality of one feature, or more features in combination, orchestrate functions selected from a list including dispensing of biomolecules, dislodging particles, reabsorbing oral fluids, trapping microbes and particles, producing a solid expectorant, conducting insitu reactions, dispensing of medically significant molecules, delivering timed release of biomolecules, delivering heat of reaction, gas, or pressure.
A Disposable Mouth Chip

3. A disposable mouth chip comprising:
a hydrophilic, open cell foam or sponge embodiment of small enough size for chewing comprising of one or multitude of surface features selected from a group comprising: pegs, bristles, ridges, and grooves, surface pores, fiberoptic strands, tassel or floss, wings or functional architecture for dynamic effect, and in combination with one or multitude of embedded features selected from a group that includes: pod, pod channel, high density foam or variable density polymer, hydrophobic lining, closed cell polymer lining, polyol brittle shield, polyol brittle capsule, dentifrice, medically significant molecules, chemical reactants as means for production of gas, heat or molecules.
Chewable Micro-Laboratory

4. A small enough, chewable, polymeric structure for insitu chemical reaction comprising:
(a) a pod or multitude of pods, lined by sufficiently thin layer of hydrophobic or closed cell polymer, surrounded by a sufficiently thicker layer of open cell hydrophilic polymer; therein including biomolecules, reactants, or active ingredients for purpose of delivery and consumption,
(b) a pod channel or multitude of pod channels conducting pod content to surface pore,
(c) a surface pore or multitude of surface pores whereby flow rate of outlet from the said pod to the oral cavity is controlled or regulated,
(d) a brittle shield that's breakable with small enough force is sandwiched between two pods,
whereby chewing on the embodiment would result in breakage of the brittle shield and pod lining, followed by intermixing of the pods' content, and production of a desirable reaction between reactants to produce heat, gas, pressure jets, or other biomolecules of significance that is extruded out through surface pores, as described by Boyle's Law.
Insitu Oral Reactor

5. A small enough, chewable, polymeric structure for insitu chemical reaction comprising:
(a) a pod or multitude of pods, lined by sufficiently thin layer of hydrophobic or closed cell polymer, surrounded by a sufficiently thicker layer of open cell hydrophilic polymer; therein including biomolecules, reactants, active ingredients for purpose of delivery and consumption,
(b) a pod channel or multitude of pod channels conducting pod content to surface pore,
(c) a surface pore or multitude of surface pores whereby flow rate of outlets from the said pod to the oral cavity is controlled or regulated,
(d) a brittle capsule, or multitude of brittle capsules, that's breakable with small enough force, placed within the pod, whereby contents therein said capsule can react with content external to the capsule,
whereby chewing on said capsule or capsules within a pod, may break the capsule and allow an intended reaction to produce heat, gas, pressure jets, or other biomolecules of significance that can extruded out through surface pores, as described by Boyle's Law.
Chewable Dispensary

6. A polymer foam embodiment of predetermined dimensions and shape for purpose of dispensing dentifrice, biomolecules, or medically significant molecules with an outer structure comprising:
(a) open cell polymer scaffolding that disburse energy in omni-directions similar to fluid dynamics described by Pascal's Principle,
(b) surface optional features selected from a list that include: pegs, bristles, ridges, and grooves, surface pores, fiberoptic strands, tassel or floss, wings or anatomic functional architecture for dynamic effect,
and an inner structure, laden within the outer structure, comprising:
(c) a pod or multitude of pods,
(d) one or multitude of pod channels connecting said pod within the embodiment to outside dimension of embodiment,
whereby chewing on the embodiment cause extrusion of content of said pod through said pod channel into oral cavity.
Disposable, Chewable Light Module

7. Marriage of said foam as described in claim 1 with multitude of fiberoptic strands by means of attachment on lateral surfaces of the foam or embedding within the substance of the foam that channel ultra violet or blue light directly to teeth for whitening, or infrared light to gums for post surgical therapy, having coursed the distance from the optoelectric light module to the anterior face of the foam, traveling through its embodiment, or stuck to lateral aspect of the embodiment piercing through the lateral aspect of wings, to surface above to superior surface, and below to inferior surface, sprouting through to a distance short enough to deliver said light to medial and lateral aspects of teeth that said strands must supply by reason of design.

8. The dental embodiment of claim 1, wherein light from an optoelectric module is transmitted through fiberoptic strand, having coursed the distance from the optoelectric light module to the anterior face of the foam, traveling through its embodiment, or stuck to lateral aspect of the embodiment, by means of attachment, piercing through the lateral aspect of wings, to surface above to superior surface, and below to inferior surface, sprouting through to a distance short enough to deliver said light to bundles of clear bristles, attached at sufficiently angulated position and attached by means of attachment, having said light projected into said clear bristles thereby providing light with each brush stroke of bristles against dentine, gum line, interocclusal surfaces, margins, dental sulci where plaques and biofilm form.

9. The dental embodiment of claim 1, further including a selection from the group including: a tassel or floss as means to secure user of accidental swallowing of said embodiment; fiberoptic strands to carry an electromagnetic wave range of infrared to UV light, for gums in post-surgical therapy, and for teeth in dental bleaching, having coursed space as in claim 7 or claim 8; bristles for brushing; pegs for scaling; grooves for increased surface area of said embodiment; ridges for massaging oral surfaces; high density layer for supporting form and function; structural design that support functional dynamic shape change, as an example wings, sufficiently angled bristles; multitude of pods, for storage of viscous content; and pod channels to deliver said content to surface; and surface pores for controlled extrusion of said content.
Solid Expectorant Foam

10. An absorptive solid expectorant foam, consumed for oral hygiene, drug delivery, or insitu chemical reaction comprising of:
(a) foam architecture as in claim 1,
(b) molded in reasonable dimensions for chewing by general public in toddler, pediatric, and adult sizes, with diversity of shape and colors by merits of design for appeal by target markets selected from a group including: toddler, children, adolescent, adult, elderly, and disabled.
Method of Manufacturing Pod Cartridge

11. A method of manufacturing tandem double blister pods of variable geometric shapes by bringing together a 3 layered wafer comprising:
(a) a top layer of hydrophobic polymer sheath,
(b) a bottom layer of hydrophobic polymer sheath,
(c) sandwiching a middle sheath of polyol brittle shield,
with edges of said three layers of wafer fused by means of adhesion in all mesial surfaces in apposition, and pressed in time proximity reasonably before injection of predetermined pod contents, whereby pod contents are sealed within pod chambers.
Angular Bristles

12. Bristle bundles, sorted directionally by the variable of curvature of each bristle fiber, and polarity of bristle as measured by maximum lumens of light transmission through each fiber, attached by means of attachment to the foam as in claim 1, in the way that bristles attached sufficiently lateral to a line drawn longitudinally through said foam's median, and attached to both superior and inferior surfaces of the said foam, with a sufficiently inward angle to the median line, whereby said bristle bundles experience dynamic movements by torsions from within the foam, generated by chewing.
Pods

13. Pods comprised of:
pod lining fashioned by closed cell polymer, or hydrophobic polymer, that's thin enough and soft enough for chewing, engulfing a central cavity comprising of smaller pod spaces created by at least
(a) one layer of said closed cell polymer, or hydrophobic polymer,
(b) and at least one layer of breakable brittle shield or at least one brittle capsule, made breakable by means of shearing, stippling, scoring, or etching,
whereby said shield or capsule separate a reactant from another by the thickness of the wall of their substance, whereby a small enough force external to the central cavity shattering said shield, or capsule can allow a predetermined reaction between the pod contents to occur.

14. The DMC pods as in claim 13 encased within the DMC foam structure as in claim 1, or the outer structure as in claim 6, or a DMC jacket limited to closed cell polymer, or a DMC jacket limited to the high density layer with optional surface features selected from a group including: dentifrice, bristle, ridge, peg, groove, surface pore, fiberoptic strands, tassel or floss, medically significant molecules, or reactants, whereby said foam and at least one to a plurality of one feature, or more features in combination, orchestrate functions selected from a group including: dental/oral brushing, dental/oral massaging, dislodging particles, reabsorbing oral fluids, reabsorbing particles and bacteria, producing a solid expectorant, conducting an insitu reaction, dispensing or delivering medically significant molecules.
Article of Oral Massage

15. Polymeric foam of molecular architecture of claim 1 with surface features selected from a group: ridges and grooves, pegs and bristles, peripherally positioned to the embodiment's dimensions, with the said embodiment sufficiently soft enough for chewing.
Oral Article of Automatic Brushing

16. Polymeric foam of claim 1, with fluid dynamic distribution of forces similar to liquids, in omnidirections as described by Pascal's Principle, generating circular torques within its embodiment, in translation to vertical forces rendered by temporomandibular joint, anatomically changing shape described as functional dynamic shape changes, while dictating the force of its bodily torsions to angulated, directionally sorted, polar, bristles as in claim 12, whereby chewing on the embodiment translates to automatic brushing of medial and lateral surfaces of teeth in contact with the embodiment.
